(19) United States
(12) Patent Application Publication
(10) Pub. No.: US 2012/0118129 A1
(43) Pub. Date: May 17, 2012

(54) Electromagnetic pickup with multiple wire coils wound around individual pole sets to attain multiple tones

(76) Inventor: Changsoo Jang, San Jose, CA (US)

(21) Appl. No.: 12/946,948

(22) Filed: Nov. 16, 2010

(51) Int. Cl. G10H 3/18

(52) U.S. Cl. 84/726

(57) ABSTRACT

An electromagnetic pickup for electric guitars has a plural of wire coils around each pole set and two lead wires connected to each wire coil. Individual wire coils around a pole set have different oxygen contents and/or gages and/or turns and/or coating materials such that one wire coil produces a tone color distinctive from another wire coil.

### BACKGROUND OF THE INVENTION

This invention relates to electric guitars, and more specifically, electromagnetic pickups used in electric guitars. An electromagnetic pickup (pickup, hereinafter) converts the vibrations of plucked strings of the electric guitar, which are located on top of the pickup where electromagnetic fields are formed, into an electrical signal. In general a single coil pickup (SC pickup, hereinafter) comprises of a set of pole pieces made of magnetic or ferromagnetic materials, copper wires wound around the bobbin or pole pieces, frame and lead wires. The SC pickup is sensitive to external magnetic fields created by speakers, power transducers, fluorescent light sources, etc. An exposure to such magnetic fields causes undesired humming and noise. A hum-cancelling pickup was introduced by Lover (U.S. Pat. No. 2,896,491 granted in 1959). This “humbucking” pickup (HB pickup, hereinafter) is in principle a combination of two SC pickups which are connected both electrically and magnetically out-of-phase. This configuration cancels signal sources externally radiated onto two coils while maintaining in-phase with the signal from strings.

A pickup has a unique response characteristic to string vibrations resulting in a unique tone color. The pickup tone is dependent on many parameters, which include magnet materials, pole structures, bobbin materials and structures, oxygen content of copper wire, copper wire gage, copper wire coating materials, the number of wire turns and so on. Although external factors such as guitar builds, effects pedals and amplifiers can modify the tone characters to some extent, they cannot completely override the original tone color of the pickup. That is why old classical pickups are still popular, and also, a tremendous number of different pickup products are used in the music industry.

When one wants to make a different tone from a guitar, he/she should replace the pickup with another one with a desired tone. If he/she likes the existing pickup sound but needs more tone character, he/she should purchase another guitar with a different pickup set, which often ends up wasting time and money due to uncontrollable variations in guitar builds. A simple question arises: can a single HB pickup produce two or more distinctive tones? The existing art of the HB pickup essentially offers a “fixed” tonality. The only known way to change the pickup sound without replacing the pickup is coil split and parallel/serial arrangement with HB pickups. However, it is nothing but utilization of fixed tonality of two separate SC pickups comprising the HB pickup, and thus, it cannot make fundamental differences in tones. In other words, this method cannot truly produce two different HB tones out of a single HB pickup. Furthermore, the coil-tapped pickup sound is in general much worse than a genuine SC pickup sound. On the other hand, to make the coil-tapped pickup sound decent, one should sacrifice the character of the HB tone, which is usually warmer and fuller than the SC tone.

The primary object of this invention is to attain multiple tones out of a single HB pickup configuration using multiple wire coils with different specifications wound around a single set of poles comprised of 6 or 7 individual pole pieces.

### SUMMARY OF THE INVENTION

As mentioned above, the key of this invention is to wind a plural of wire coils with different specifications (oxygen content, gage, turns, coating materials) around a pole set used in a HB pickup, wherein two pole set/bobbin and wire assemblies are situated side by side.

It would be easier to illustrate how it works if an example is taken here. One of the most classical and long-beloved HB pickups would be the “PAF” (Patent Applied For) pickup based on Lover's patent in 1959. It features AINiCo V magnet and 42 AWG (American Wire Gage) Enamel-coated copper wire. The typical resistance ranges 7 to 8 kΩ. On the other hand, one of the most popular “modern” pickups is the JB model by Seymour Duncan, which is also based on the same configuration with AINiCo V magnet but has a wire coil set with a resistance of 16.4 kΩ. This type of modern high power pickups uses thinner gage copper wire (43 or 44 AWG) to accommodate more turns around bobbins. In order to get both tones from a single HB pickup, two sets of wires with 42 AWG and 44 AWG can be wound around each pole set simultaneously or subsequently or separately. Each wire coil is connected to two external lead wires (leads, hereinafter) resulting in 8 leads in total (plus a shield wire). A switch or a set of switches can be used to combine two wire coils from two bobbins. If two 42 AWG wire coils are connected, one can attain a PAF-like tone, while one can attain a JB-like tone by combining two 44 AWG wire coils. Meanwhile, several more tones can be obtained by connecting one 42 AWG from one side and one 44 AWG from the other side or by taking serial/parallel connections of two coils in each side and then connecting those two combinations. By doing so, one can utilize at maximum 3×3=9 different HB tones from the single HB pickup through “dual-coil” winding.

The application of this invention is not limited to the said dual-coil setup. By using thinner gage wires and/or enlarge the winding space, one can wind as many wire coils around the bobbin as the bobbin space allows. In effect this invention makes the pickup very versatile in terms of tonality.

### BRIEF DESCRIPTION OF THE DRAWINGS

Note that the schematics used in this document are not to scale. For simplicity, only the case of dual wire coils per pole set/bobbin assembly is illustrated in the figures and the extension to more wires is not considered further because implementation of more than two wire coils is intuitive and obvious even without illustrations. This document assumes all the electrical connections shown in the figures follow the well-established art of HB wiring (e.g., in-phase and out-of-phase wiring), and thus, phase information is not specified in the drawings. This document also assumes that all embodiments of this invention follow the known art of magnet and pole dispositions within the “PAF” type HB pickup (based on Lover's patent, 1959), which have been well established, published and commercialized.

FIG. 1 illustrates a top view of HB pickup

FIG. 2 illustrates two side views with partial cross-section

FIG. 3 illustrates a simplified diagram of pole set/bobbin and wire assembly

FIG. 4 illustrates examples of embodiment of the present invention onto a pole set/bobbin and wire assembly

FIG. 5 illustrates leads from dual-coil pole set/bobbin and wire assembly

FIG. 6 illustrates an example of embodiment of the present invention onto HB pickup with one bobbin for each side

FIG. 7 illustrates an example of embodiment of the present invention onto HB pickup with two bobbins for each side

### DETAILED DESCRIPTION

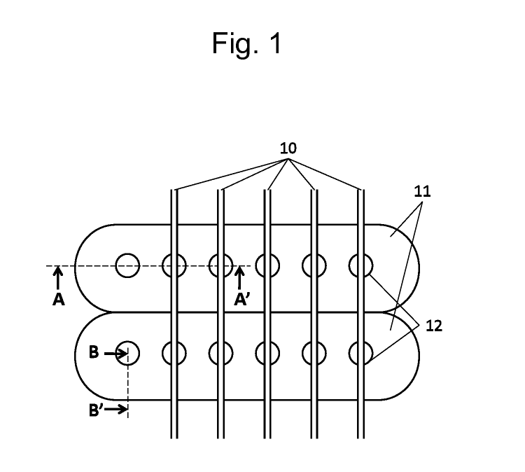

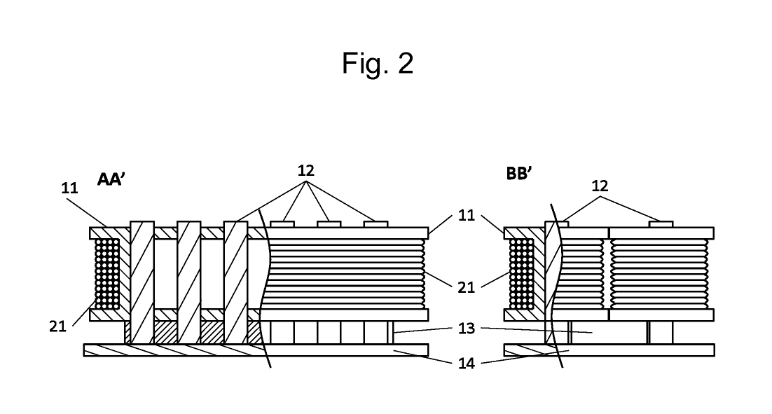

FIG. 1 shows a top view of a generic HB pickup placed underneath strings 10. The corresponding side views and partial cross-sectional diagrams are illustrated in FIG. 2. The pickup shown in the figures comprises of two bobbins 11, non-magnetic pole pieces 12, a magnet bar 13, a bottom plate 14, and two sets of wire coils 21. The pole pieces 12 are put inside and run through the bobbin 11 and the magnet bar 13 is situated on the bottom side of the bobbin 11. When magnetic pole pieces are used, the magnet 13 is not required. The role of magnet bar or magnetic poles is to form a magnetic field around the strings 10. The wire coil 21 is wound around the pole set 12 so that vibration of the strings 10 is converted to electrical signal through the wire 21.

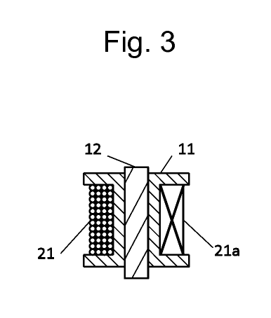

In order to illustrate the embodiment of the present invention more effectively a simplified diagram is used in FIG. 3. Only one side of the HB pickup which contains the bobbin 11, the pole piece 12 and the wire 21 is included in the figure. The pole set consists of 6 or 7 pole pieces depending on the number of strings used in an electric guitar. On the right-hand side the wire 21 is simplified as a box with two crossing lines 21a. The following figures will use this simplified illustration of the bobbin 11, pole piece 12 and wire 21a assembly.

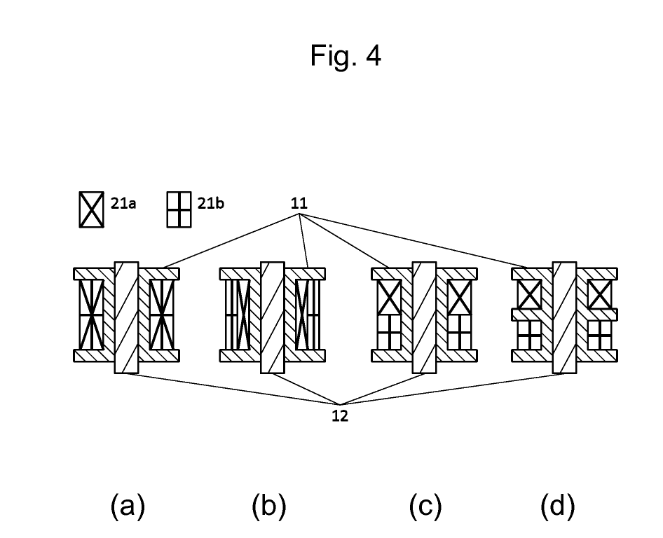

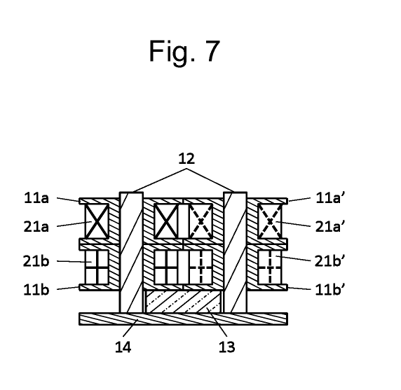

FIG. 4 illustrates four examples of implementation of dual wire coils (21a and 21b) around a pole set 12/bobbin 11 assembly. Four wire configurations shown in FIG. 4(a) through (d) are:
(a) Two different wires, 21a and 21b, are wound simultaneously thus they are mingled around the bobbin 11. One wire with more turns may have to be wound further after winding of the other wire is finished.
(b) One wire 21a is wound first, and subsequently, the other wire 21b is wound on top of the other.
(c) One wire 21a is wound around the upper part of the bobbin 11, and at the same time or subsequently, the other wire 21b is wound around the lower part of the bobbin 11.
(d) This configuration is essentially the same as (c). For precise winding a plate made of thin plastic (for example) is used between two coil spaces to separate two wire coils. Another similar embodiment is that two separate bobbins are aligned, stacked, and then assembled with long pole pieces running through them (also see FIG. 7).
   Many more combinations are possible to wind two or more wires around the pole set 12/bobbin 11 assembly.

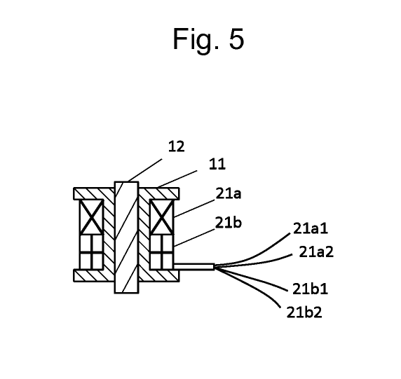

Two ends of each wire are connected to leads for wiring to external circuits and amplifiers. FIG. 5 shows an example of leads from the dual wire coils. Note that the diagram of the pole set 12/bobbin 11 and wire 21a/21b assembly was taken from FIG. 4(c) just for illustration. The wire 21a is connected to two external leads 21a1 and 21a2, and the other wire 21b to 21b1 and 21b2. The total number of leads (minus an optional shield wire) is calculated by: 2 sides×2 leads×(number of wires wound in each pole set/bobbin assembly).

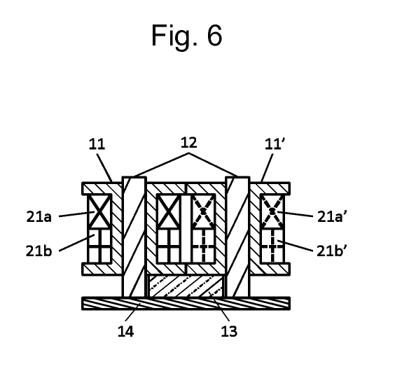

FIG. 6 illustrates an example of the embodiment of the present invention onto the HB pickup wherein two dual coil pole set/bobbin assemblies are combined side by side. Around one bobbin 11, two wire coils, 21a and 21b, are wound and around the other bobbin 11′, another two wire coils, 21a′ and 21b′, are wound. Both pair of the wire coils can be identical or different depending upon the need of tonal variability.

FIG. 7 illustrates an example of dual coil configuration but with two bobbins per side 11a and 11b or 11a′ and 11b′. In each side two bobbins are aligned, stacked and assembled using pole pieces 12 running through them. Around each bobbin a coil wire 21a˜21b′ with a certain specifications is wound as needed. More than two bobbins can be stacked at each side depending on the need of tonal variability.

What is claimed is:

1. An electromagnetic pickup with humbucking configuration (the said HB pickup) wherein two pole set/bobbin and wire assemblies are situated side by side and one wire from one pole set/bobbin assembly is electrically connected to one wire from the other assembly such that two wires are electrically in-phase or out-of-phase, and wherein at least one of the two pole set/bobbin assemblies contains a plural of wire coils with different specifications in terms of oxygen contents and/or gages and/or turns and/or coating materials.

2. An electromagnetic pickup with the humbucking configuration wherein two pole set/bobbin and wire assemblies are situated side by side and one wire from one pole set/bobbin assembly is electrically connected to one wire from the other assembly such that two wires are electrically in-phase or out-of-phase, wherein at each side of pole set/bobbin and wire assembly, a plural of bobbins are aligned, stacked, and assembled with pole pieces running through them, wherein each bobbin is wound with a wire coil with a certain specifications, and wherein a plural of bobbins in the same side are wound with wire coils with different specifications in terms of oxygen contents and/or gages and/or turns and/or coating materials.

3. An electromagnetic pickup with the humbucking configuration as claimed in claims 1 and 2, wherein the pole pieces are either magnetic or non-magnetic.
